(19) United States
(12) Patent Application Publication
(10) Pub. No.: US 2012/0008532 A1
(43) Pub. Date: Jan. 12, 2012

(54) WIRELESS COMMUNICATION APPARATUS AND METHOD OF TRANSMITTING SUB-PACKETS

(75) Inventors: Kenichi Miyoshi, Kanagawa (JP); Megumi Ichikawa, Kanagawa (JP); Daichi Imamura, Kanagawa (JP); Seigo Nakao, Kanagawa (JP)

(73) Assignee: PANASONIC CORPORATION, Osaka (JP)

(21) Appl. No.: 13/141,181

(22) PCT Filed: Dec. 24, 2009
(86) PCT No.: PCT/JP2009/007195

§ 371 Date: Jul. 27, 2011

(30) Foreign Application Priority Data
Dec. 24, 2008 (JP) 2008-328286
Mar. 27, 2009 (JP) 2009-079675

(51) Int. Cl. H04W 92/00

(52) U.S. Cl. 370/310

(57) ABSTRACT

A wireless communication apparatus enabling improved system throughput while limiting the amount of signaling for feedback information. In this apparatus, a setting unit (101) sets transmission power differently for each of a plurality of sub-packets obtained by dividing transmission data (transmission packet). Here, the setting unit (101) sets transmission power differently for each of the plurality of sub-packets so that the total transmission power for the plurality of sub-packets becomes the same as the transmission power that is allocated in advance to the transmission packet that constitutes the plurality of sub-packets. A dividing unit (102) divides the transmission data (transmission packet) into a plurality of sub-packets. Then, a transmitting wireless communication apparatus (100) transmits the plurality of sub-packets in order of sub-packets of higher transmission power (lower error rate).

### TECHNICAL FIELD

The present invention relates to a radio communication apparatus and a sub-packet transmission method.

### BACKGROUND ART

The error control technology such as FEC (Forward Error Correction code) and ARQ (Automatic Repeat reQuest) has focused as a technology to realize high-speed transmission. Also, HARQ (Hybrid ARQ) combining FEC and ARQ is being examined.

According to HARQ, a radio communication apparatus on a receiving side gives feedback to a radio communication apparatus on a transmitting side by transmitting an ACK (Acknowledgment) signal if there is no error in reception data and an NACK (Negative Acknowledgment) signal if there is an error as a response using an error detection code such as a CRC (Cyclic Redundancy Check) code. The radio communication apparatus on the receiving side joins data retransmitted from the radio communication apparatus on the transmitting side and data received in the past and having an error and performs error correction decoding on the composite data. Accordingly, SINR (Signal to interference plus Noise power Ratio) is improved and coding gain is increased so that reception data can be decoded with a smaller number of times of retransmission than the common ARQ.

In an HARQ system, two methods of the Go-Back-to-N (hereinafter, referred to as GBN) method (see, for example, Patent Document 1) and the Selective Repeat (hereinafter, referred to as SR) method (see, for example, Patent Document 2) are examined as methods to improve system throughput. In the description that follows, an HARQ system in which the radio communication apparatus on the transmitting side divides a transmission packet into a plurality of sub-packets to perform retransmission processing in sub-packets.

In the GBN method, the radio communication apparatus on the receiving side receives data of a window size (for example, a plurality of sub-packets for one packet) transmitted by the radio communication apparatus on the transmitting side at a time to perform error correction decoding on the plurality of sub-packets. The radio communication apparatus on the receiving side performs the error correction decoding on the plurality of sub-packets one after another and, when an error is detected in one of the sub-packets, gives feedback of an NACK signal and the sub-packet number of the sub-packet in which an error is detected to the radio communication apparatus on the transmitting side. Then, the radio communication apparatus on the transmitting side retransmits sub-packets starting with the sub-packet number given as feedback to the radio communication apparatus on the receiving side in the next window.

In the SR method, the radio communication apparatus on the receiving side performs error correction decoding on all data of the window size (a plurality of sub-packets) transmitted by the radio communication apparatus on the transmitting side at a time. Then, if an error is detected in one of sub-packets, the radio communication apparatus on the transmitting side gives feedback of an NACK signal and sub-packet numbers of all sub-packets in which an error is detected to the radio communication apparatus on the transmitting side. Then, the radio communication apparatus on the transmitting side retransmits sub-packets of sub-packet numbers given as feedback (that is, all sub-packets in which an error is detected) to the radio communication apparatus on the receiving side in the next window.

### Citation List

### Patent Literature

PTL 1
Japanese Patent Application Laid-Open No. 03-178232
PTL 2
Japanese Patent Application Laid-Open No. 2007-336583

### SUMMARY OF THE INVENTION

### Technical Problem

In the GBN method, sub-packets without error may also be retransmitted during retransmission. A concrete description will be provided below using FIG. 1. In FIG. 1, one transmission packet is divided into five sub-packets (sub-packets #1 to #5). ‘◯’ shown in FIG. 1 indicates that there is no error in the sub-packet and ‘X’ indicates that there is an error in the sub-packet.

In the GBN method, the radio communication apparatus on the receiving side performs decoding processing starting with sub-packet #1 one by one and, if an error occurs in some sub-packet (a case of ‘X’), gives feedback of the sub-packet number (retransmission number shown in FIG. 1) of the sub-packet to the radio communication apparatus on the transmitting side. Then, the radio communication apparatus on the transmitting side retransmits the sub-packet in which an error occurred and subsequent sub-packets. If the presence/absence of an error of sub-packets #1 to #5 is (‘◯’, ‘X’, ‘◯’, ‘◯’, ‘X’) like, for example, Error pattern 9 shown in FIG. 1, the radio communication apparatus on the receiving side gives feedback of a response signal ‘MACK’ and the retransmission number (sub-packet number) ‘2’ to the radio communication apparatus on the transmitting side. The radio communication apparatus on the receiving side does not perform decoding processing of sub-packet #3 and thereafter. Then, the radio communication apparatus on the transmitting side retransmits sub-packets #2 to #5 of sub-packet number #2 and subsequent sub-packet numbers.

In this case, sub-packets #3 and #4 have no error and thus, retransmission of two sub-packets of sub-packets #3 and #4 is wasteful retransmission. Thus, in Error pattern 9, for example, the ratio (wasteful retransmission rate) of wastefully retransmitted sub-packets (sub-packets #3 and #4) to the retransmitted four sub-packets (sub-packets #2 to #5) is 2/4.

Thus, in the GBN method, retransmission of sub-packets having no error (sub-packets of ‘◯’ surrounded by oblique lines shown in FIG. 1) subsequent to the sub-packet in which an error occurred may occur. As shown in FIG. 1, wasteful retransmission occurs in 26 patterns of Error patterns 0 to 31 of sub-packets #1 to #5. Therefore, according to the GBN method, sub-packets having no error are wastefully retransmitted, leading to lower throughput.

In the SR method, by contrast, the radio communication apparatus on the receiving side gives feedback of sub-packet numbers of all sub-packets in which an error was detected to the radio communication apparatus on the transmitting side and the radio communication apparatus on the transmitting side retransmits only sub-packets of sub-packet numbers given as feedback. According to the SR method, the wasteful retransmission described above does not occur and thus, compared with the GBN method, higher throughput can be obtained. However, according to the SR method, the amount of signaling necessary to give feedback of sub-packet numbers of sub-packets having an error becomes larger than that of the GBN method.

Specifically, according to the GBN method, the radio communication apparatus on the receiving side needs to give feedback of one sub-packet number of sub-packet #1 to #5 shown in FIG. 1 and thus, feedback information has five patterns (Retransmission numbers 1 to 5 shown in FIG. 1) and six patterns if a pattern having no error (pattern 0 shown in FIG. 1) is included. Thus, the amount of signaling becomes 3 bits (eight states of 1 to 8 can be represented by 3 hits so that six patterns of error patterns 0 to 5 can be represented). In the SR method, by contrast, it is necessary for the radio communication apparatus on the receiving side to give feedback of sub-packet numbers of sub-packets of sub-packets #1 to #5 in. which an error occurred. That is, according to the SR method, it is necessary to indicate all error patterns in sub-packets #1 to #5 as feedback information. Specifically, error patterns when there are errors in sub-packet #1 to #5 have 31 patterns (Error patterns 1 to 31 shown in FIG. 1) and 32 patterns if a pattern having no error (pattern 0 shown in FIG. 1) is included. Thus, the amount of signaling becomes 5 bits (32 states of 1 to 32 can be represented by 5 bits so that 32 patterns of error patterns 0 to 31 can be represented). Therefore, according to the SR method, compared with the GBN method, there are more error patterns, which increase the amount of signaling of feedback information.

If feedback information is in error, the system may fatally be degraded and so it is necessary to control feedback information so as not to be corrupted on a transmission path. Specifically, processing to make feedback information less error-prone is performed by performing strong error correction coding processing on the feedback information or providing large transmission power. Accordingly, consumption of radio resources by feedback information becomes very large. Further, in a mobile communication system such as a cellular system, a lot of radio communication apparatuses perform communication mutually and if the amount of signaling increases for each radio communication apparatus, communication of the whole system may be affected.

An object of the present invention is to provide a radio communication apparatus capable of improving system throughput while suppressing the amount of signaling of feedback information and a sub-packet transmission method.

### Solution to Problem

A radio communication apparatus according to the present invention adopts a configuration including a division section that divides a transmission packet into a plurality of sub-packets, a setting section that sets a mutually different error rate to each of the plurality of sub-packets, and a transmission section that transmits the plurality of sub-packets in ascending order of the error rate.

A sub-packet transmission method according to the present invention includes a setting step of setting a mutually different error rate to each of a plurality of sub-packets obtained by dividing a transmission packet and a transmission step of transmitting the plurality of sub-packets in ascending order of the error rate.

### Advantageous Effects of the Invention

According to the present invention, system throughput can be improved while the amount of signaling of feedback is suppressed.

### BRIEF DESCRIPTION OF DRAWINGS

FIG. 1 is a diagram showing error patterns in the conventional GBN method and SR method;

FIG. 2 is a block diagram of a radio communication apparatus on the transmitting side according to Embodiment 1 of the present invention;

FIG. 3 is a block diagram of the radio communication apparatus on the receiving side according to Embodiment 1 of the present invention;

FIG. 4 is a diagram showing transmission power of each sub-packet according to Embodiment 1 of the present invention;

FIG. 5 is a diagram showing retransmission processing according to Embodiment 1 of the present invention;

FIG. 6 is a diagram showing error patterns according to Embodiment 1 of the present invention;

FIG. 7 is a block diagram of the radio communication apparatus on the transmitting side according to Embodiment 2 of the present invention;

FIG. 8 is a diagram showing a coding rate of each sub-packet according to Embodiment 2 of the present invention;

FIG. 9 is a diagram showing sub-packets after being coded according to Embodiment 2 of the present invention;

FIG. 10 is a diagram showing overheads due to CRC addition according to Embodiment 3 of the present invention;

FIG. 11 is a diagram showing sub-packets after being LDPC-coded according to Embodiment 3 of the present invention;

FIG. 12 is a diagram showing retransmission processing according to Embodiment 4 of the present invention;

FIG. 13 is a diagram showing the coding rate of sub-packets according to Embodiment 5 of the present invention;

FIG. 14 is a diagram showing the other coding rate of sub-packets according to Embodiment 5 of the present invention.

FIG. 15 is a diagram showing the coding rate of sub-packets according to Embodiment 6 of the present invention (for initial transmission);

FIG. 16 is a diagram showing the coding rate of sub-packets according to Embodiment 6 of the present invention (for retransmission); and

FIG. 17 is a diagram showing the coding rate of sub-packets according to Embodiment 6 of the present invention (for retransmission).

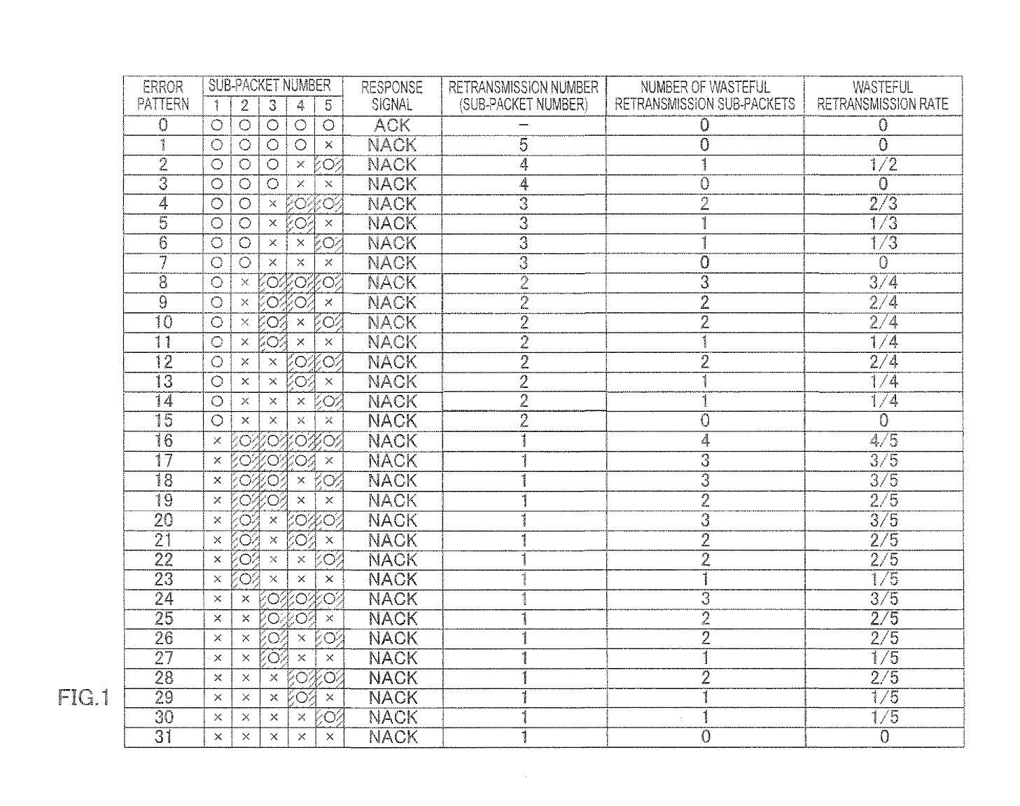

### DESCRIPTION OF EMBODIMENTS

The embodiments of the present invention will be described in detail below with reference to appended drawings.

### Embodiment 1

In the present embodiment, a radio communication apparatus on the transmitting side sets a mutually different error rate to each of a plurality of sub-packets obtained by dividing a transmission packet.

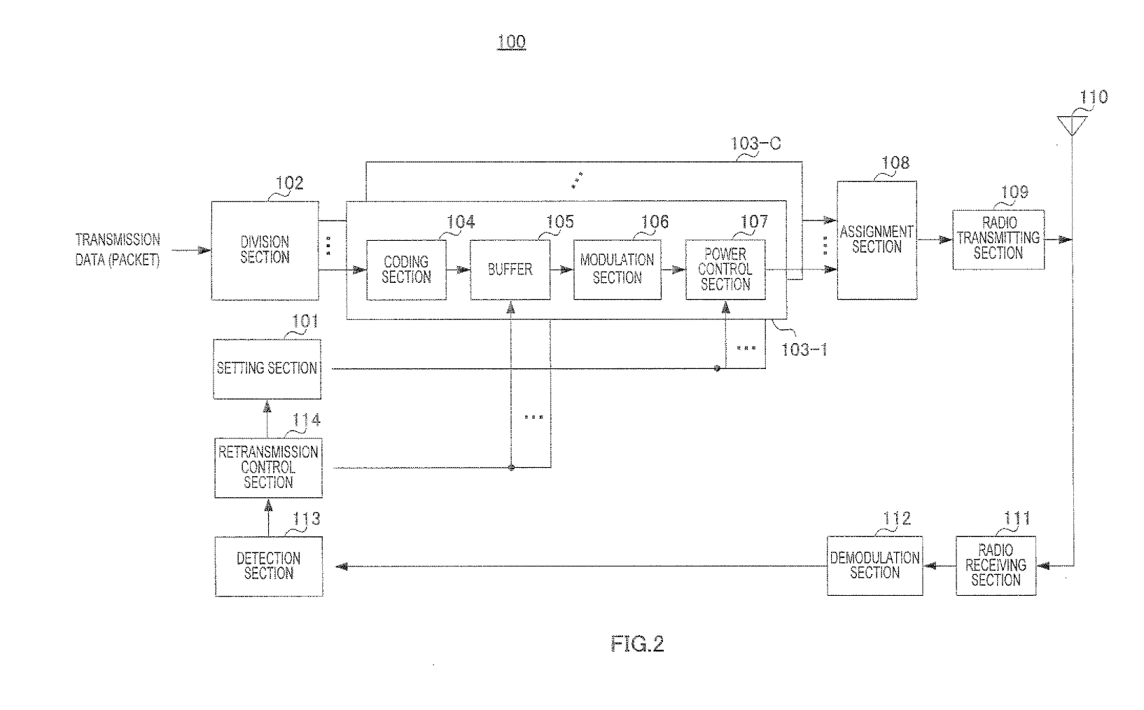

The configuration of radio communication apparatus 100 on the transmitting side according to the present embodiment is shown in FIG. 2.

In radio communication apparatus 100 on the transmitting side, setting section 101 sets transmission power to a plurality of sub-packets obtained by dividing transmission data (transmission packet). Specifically, setting section 101 sets mutually different transmission power to each of the plurality of sub-packets. Here, setting section 101 sets mutually different transmission power to each of the plurality of sub-packets so that the total of transmission power of the plurality of sub-packets becomes equal to the transmission power assigned to the transmission packet constituting the plurality of sub-packets in advance. For initial transmission or retransmission, setting section 101 sets transmission power of a sub-packet to be initially transmitted or retransmitted according to sub-packet information input from retransmission control section 114 and indicating the sub-packet to be retransmitted. Then, setting section 101 outputs transmission power information indicating the set transmission power to each power control section 107 of sub-packet processing sections 103-1 to 103-C.

Division section 102 has transmission data (transmission packet) input thereinto. Division section 102 divides the transmission data (transmission packet) into a plurality of sub-packets. Then, division section 102 outputs the obtained plurality of sub-packets to each coding section 104 of corresponding sub-packet processing section 103-1 to 103-C.

Each of sub-packet processing sections 103-1 to 103-C includes coding section 104, buffer 105, modulation section 106, and power control section 107. As many sub-packet processing sections 103-1 to 103-C as number C of sub-packets obtained by dividing transmission data (transmission packet) transmitted by radio communication apparatus 100 on the transmitting side at a time are provided.

In sub-packet processing sections 103-1 to 103-C, coding section 104 performs coding processing on sub-packets input from division section 102. Then, coding section 104 outputs sub-packets after being coded to buffer 105.

Buffer 105 outputs sub-packets input from coding section 104 to modulation section 106 and also saves sub-packets for a predetermined time. Then, if an instruction to discard sub-packets is input from retransmission control section 114 (if the response signal is an ACK signal), buffer 105 discards saved sub-packets. On the other hand, if an instruction to retransmit is input from retransmission control section 114 (if the response signal is an NACK signal), buffer 105 outputs saved sub-packets to modulation section 106 again. In this manner, the HARQ is applied to sub-packets.

Modulation section 106 generates data symbols by modulating sub-packets input from buffer 105. Then, modulation section 106 outputs the generated data symbols to power control section 107.

Power control section 107 outputs sub-packets input from modulation section 106 to assignment section 108 by controlling transmission power thereof based on transmission power information input from setting section 101.

Assignment section 108 assigns data symbols (sub-packets) input from each power control section 107 of sub-packet processing sections 103-1 to 103-C to physical channel resources. For example, assignment section 108 assigns sub-packets in descending order of transmission power to the head of physical channel resources one by one. Accordingly, the plurality of sub-packets is transmitted in descending order of transmission power. Then, assignment section 108 outputs data symbols assigned to physical channel resources to radio transmitting section 109.

Radio transmitting section 109 performs transmission processing such as D/A conversion, amplification and up conversion on data symbols and transmits a signal obtained after the transmission processing being performed on data symbols to the radio communication apparatus on the receiving side via antenna 110.

On the other hand, radio receiving section 111 receives a control signal (feedback information) transmitted from the radio communication apparatus on the receiving side via antenna 110 and performs reception processing such as down conversion and A/D conversion on the control signal before outputting the control signal on which the reception processing has been performed to demodulation section 112. The control signal contains a response signal and sub-packet numbers given by the radio communication apparatus on the receiving side as feedback.

Demodulation section 112 demodulates the control signal and outputs the control signal after the demodulation to detection section 113.

Detection section 113 detects a response signal (an ACK signal or NACK signal) and sub-packet numbers from the control signal input from demodulation section 112. Then, detection section 113 outputs the detected response signal and sub-packet numbers to retransmission control section 114.

Retransmission control section 114 controls retransmission of sub-packets based on the response signal and sub-packet numbers input from detection section 113. Specifically, if the response signal input from detection section 113 is an ACK signal, retransmission control section 114 instructs each buffer 105 of sub-packet processing sections 103-1 to 103-C to discard saved sub-packets. On the other hand, if the response signal input from detection section 113 is an NACK signal, retransmission control section 114 instructs buffers 105 of the sub-packet processing sections corresponding to sub-packets of sub-packet numbers input from detection section 113 and subsequent thereto of sub-packet processing sections 103-1 to 103-C to retransmit saved sub-packets. If the response signal input from detection section 113 is an NACK signal, retransmission control section 114 also outputs sub-packet information indicating sub-packets to be retransmitted to setting section 101.

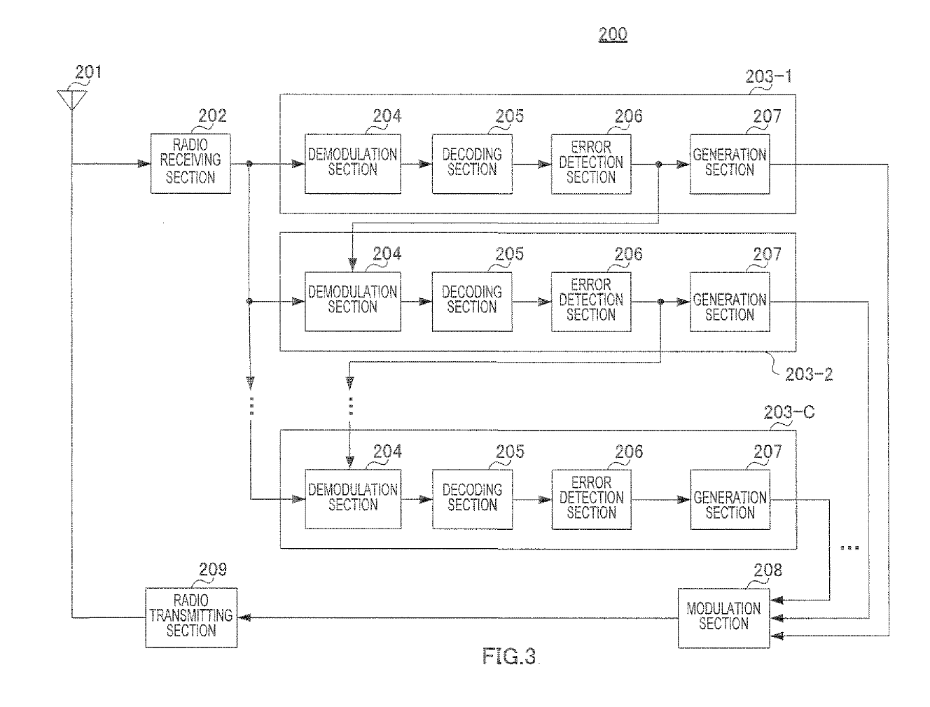

Next, the configuration of radio communication apparatus 200 on the receiving side according to the present embodiment is shown in FIG. 3.

In radio communication apparatus 200 on the receiving side, radio receiving section 202 receives a signal (a plurality of sub-packets) transmitted from radio communication apparatus 100 (FIG. 2) on the transmitting side via antenna 201 and performs reception processing such as down conversion and A/D conversion on the signal (the plurality of sub-packets). Then, radio receiving section 202 outputs each of the plurality of sub-packets to corresponding sub-packet processing sections 203-1 to 203-C.

Each of sub-packet processing sections 203-1 to 203-C includes demodulation section 204, decoding section 205, error detection section 206, and generation section 207. As many sub-packet processing sections 203-1 to 203-C as number C of sub-packets obtained by dividing data of the window size are provided. Sub-packets are input in order of sub-packet processing sections 203-1, 203-2, . . . , 203-C. That is, sub-packets are input in chronological order of reception starting with sub-packet processing section 203-1 and the sub-packet received at the latest time is input into sub-packet processing section 203-C.

in sub-packet processing sections 203-1 to 203-C, demodulation section 204 demodulates sub-packets input from radio receiving section 202 and outputs demodulated sub-packets to decoding section 205. However, each demodulation section 204 of sub-packet processing section 203-in (m=2 to C) corresponding to the second or subsequent sub-packets performs demodulation processing of sub-packets only if the error detection result input from error detection section 206 of sub-packet processing section 203-(m−1) in the previous stage indicates no error. That is, if the error detection result input from error detection section 206 of sub-packet processing section 203-(m−1) in the previous stage indicates an error, each demodulation section 204 of sub-packet processing section 203-m (m=2 to C) stops demodulation processing of sub-packets.

Decoding section 205 decodes sub-packets input from demodulation section 204 and outputs decoded sub-packets to error detection section 206.

Error detection section 206 checks sub-packets input from decoding section 205 to detect any error. Then, error detection section 206 outputs an error detection result (an error is found or no error) to generation section 207. Each error detection section 206 of sub-packet processing section 203-n (n=1 to (C−1)) other than sub-packet processing section 203-C corresponding to the last sub-packet outputs the error detection result to demodulation section 204 of sub-packet processing section 203-(n+1) corresponding to the next sub-packet.

If the error detection result input from error detection section 206 indicates an error, each generation section 207 of sub-packet processing sections 203-1 to 203-C generates an NACK signal as a response signal and also generates the sub-packet number of the sub-packet in which an error is detected (that is, the sub-packet number of the sub-packet corresponding to the local processing section). Then, generation section 207 outputs a control signal including an NACK signal and the sub-packet number to modulation section 208.

On the other hand, if the error detection result input from error detection section 206 indicates no error, each generation section 207 of sub-packet processing sections 203-1 to 203-(C−1) does nothing. In contrast, generation section 207 of sub-packet processing section 203-C generates an ACK signal as a response signal. Then, generation section 207 of sub-packet processing section 203-C outputs a control signal including the ACK signal to modulation section 208.

That is, a control signal is generated only by generation section 207 of one sub-packet processing section (the sub-packet processing section in which an error is detected first or last sub-packet processing section 203-C if no error is detected) of sub-packet processing sections 203-1 to 203-C.

Modulation section 208 modulates the control signal input from generation section 207 of one sub-packet processing section of sub-packet processing sections 203-1 to 203-C and outputs the modulated control signal to radio transmitting section 209.

Radio transmitting section 209 performs transmission processing such as D/A conversion, amplification and up conversion on the control signal and transmits the control signal. on which the transmission processing has been performed to radio communication apparatus 100 (FIG. 2) on the transmitting side via antenna 201.

Next, details of retransmission processing by radio communication apparatus 100 on the transmitting side and radio communication apparatus 200 on the receiving side will be described.

The transmission packet (transmission data) unit is designed by exercising control so that channel quality in RB (Resource Block) to which one transmission packet is assigned becomes constant. That is, channel quality of a plurality of sub-packets in one transmission packet is constant.

If no processing to increase/decrease transmission power between sub-packets is particularly performed, in which sub-packet of a plurality of sub-packets in one transmission packet a reception error occurs is probabilistically constant in radio communication apparatus 200 on the receiving side. In this case, it is impossible to know in which sub-packet of the plurality of sub-packets an error occurs unless error correction/decoding processing is performed on all sub-packets in radio communication apparatus 200 on the receiving side.

On the other hand, reception quality is different from sub-packet to sub-packet between sub-packets with different transmission power. Specifically, a sub-packet with higher transmission power has higher reception quality. Thus, a sub-packet with higher transmission power has more improved error rate characteristics (or decoding performance). That is, a sub-packet with higher transmission power has a lower error rate (for example, BER: Bit Error Ratio or BLER: Block Error Rate).

Thus, a difference in error rate characteristics (decoding performance) between sub-packets arises resulting from transmission power in a plurality of sub-packets having different transmission power.

Thus, in the present embodiment, radio communication apparatus 100 on the transmitting side sets mutually different transmission power to each of the plurality of sub-packets. Radio communication apparatus 100 on the transmitting side also transmits, among the plurality of sub-packets, a sub-packet having higher transmission power, that is, a sub-packet having a lower error rate at an earlier time.

A concrete description will be provided below. In the description that follows, division section 102 of radio communication apparatus 100 on the transmitting side divides one transmission packet into five sub-packets (sub-packets #1 to #5). Radio communication apparatus 100 on the transmitting side transmits sub-packets in the order of sub-packets #1 to #5. Thus, sub-packet processing sections 203-1 to 203-5 correspond to sub-packets #1 to #5 respectively in radio communication section 200 on the receiving side. 5.6 mW is assigned to the transmission packet constituting sub-packets #1 to #5 in advance as transmission power.

First, setting section 101 sets mutually different transmission power to sub-packets #1 to #5. Specifically, setting section 101 increases transmission power to make the error rate lower (less error-prone) of a sub-packet transmitted earlier. Here, setting section 101 sets mutually different transmission power to each of the plurality of sub-packets so that the total of transmission power of sub-packets #1 to #5 becomes equal to the transmission power (5.6 mW) assigned to the transmission packet constituting sub-packets #1 to #5

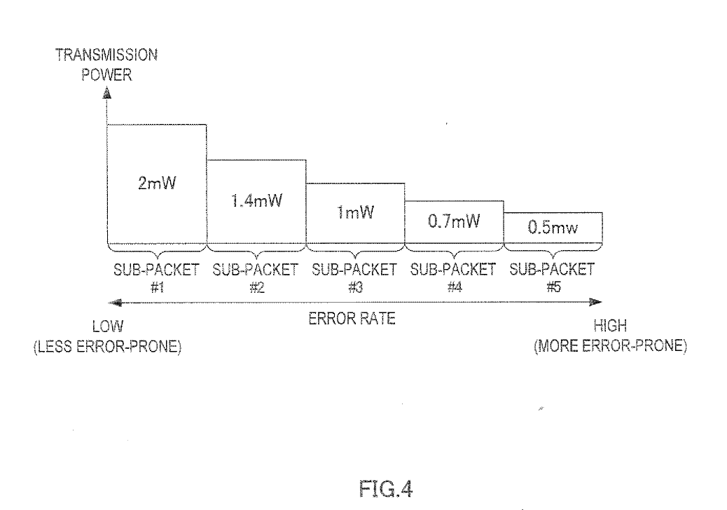

For example, as shown in FIG. 4, setting section 101 sets the transmission power of sub-packet #1 to 2 mW, the transmission power of sub-packet #2 to 1.4 mW, the transmission power of sub-packet #3 to 1 mW, the transmission power of sub-packet #4 to 0.7 mW, and the transmission power of sub-packet #5 to 0.5 mW. The total of transmission power of sub-packets #1 to #5 is 5.6 (=2+1.4 +1 +0.7 +0.5) mW.

Thus, in sub-packets #1 to #5 shown in FIG. 4, a difference in magnitude of transmission power, that is, in error rate arises and transmission power increases for a sub-packet with a lower sub-packet number (sub-packet transmitted at an earlier time). In other words, in sub-packets #1 to #5 shown in FIG. 4, a sub-packet with a lower sub-packet number has a lower error rate. By setting transmission power of each sub-packet in this manner, setting section 101 adjusts the error rate (for example, BLER) of each sub-packet.

Then, each power control section 107 of sub-packet processing sections (for example, sub-packet processing sections 103-1 to 103-5) corresponding to sub-packets #1 to #5 respectively controls transmission power of each of sub-packets #1 to #5 according to transmission power (FIG. 4) set by setting section 101.

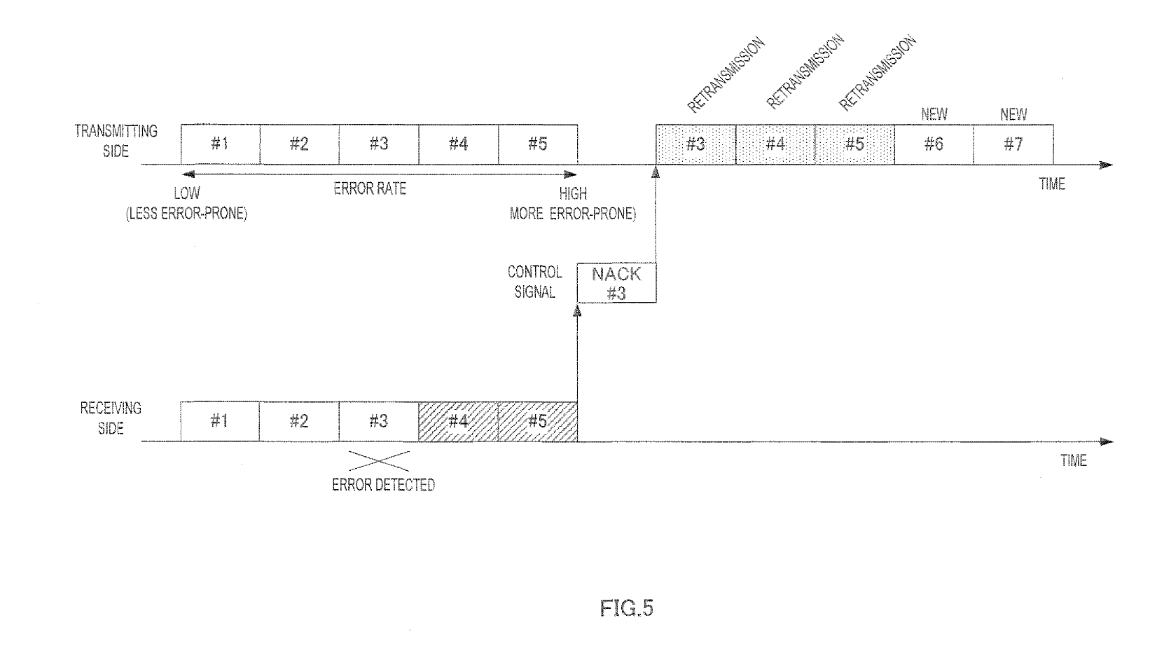

Then, radio communication apparatus 100 on the transmitting side transmits the plurality of sub-packets in descending order of transmission power. That is, radio communication apparatus 100 On the transmitting side transmits, as shown in FIG. 5, in the order of sub-packets #1, #2, #3, #4, and #5. In other words, radio communication apparatus 100 on the transmitting side transmits, among sub-packets 41 to #5, a sub-packet with a lower error rate (less error-prone) at an earlier time.

Radio communication apparatus 200 (FIG. 3) on the receiving side performs demodulation processing, decoding processing and the like (that is, sub-packet processing by sub-packet processing sections 203-1 to 203-5 shown in .FIG. 3) in the order in which sub-packets are received. That is, in radio communication apparatus 200 on the receiving side, as shown in FIG. 5, sub-packet processing is performed in the order of sub-packets #1, #2, #3, #4, and #5.

Here, as shown in FIG. 5, a case where radio communication apparatus 200 on the receiving side detects an error in sub-packet 43 will be described.

That is, sub-packet processing sections 203-1, 203-2 do not detect any error in sub-packets #1, #2 respectively (error detection result: no error) and sub-packet processing section 203-3 detects an error (error detection result: an error found). Since an error is detected in sub-packet #3, sub-packet processing sections 203-4, 203-5 stop sub-packet processing on sub-packets #4, #5 respectively.

Thus, radio communication apparatus 200 on the receiving side generates, as shown in FIG. 5, a control signal including a response signal ‘NACK’ and the sub-packet number ‘#3’ of the sub-packet in which an error was detected to give feedback of the control signal to radio communication apparatus 100 on the transmitting side.

Since the response signal included in the control signal given as feedback is ‘NACK’, retransmission control section 114 of radio communication apparatus 100 on the transmitting side instructs sub-packet processing section 103-1 to 103-5 to retransmit. Specifically, since the sub-packet number indicated in the control signal is ‘#3’, retransmission control section 114 instructs each buffer 105 of sub-packet processing sections 114 corresponding to sub-packets #3 to #5 of sub-packet processing sections 103-1 to 103-5 to retransmit. Then, each buffer 105 outputs saved sub-packets #3 to #5 to assignment section 108.

Thus, radio communication apparatus 100 on the transmitting side retransmits, as shown in FIG. 5, sub-packets #3 to #5 of the sub-packet number ‘#3’ contained in the control signal and thereafter during retransmission. The number of sub-packets (window size) that can be transmitted at a time is five, radio communication apparatus 100 on the transmitting side transmits, in addition to three sub-packets of sub-packets #3 to #5 to be retransmitted, sub-packets #6, #7 as new data (initial transmission). That is, radio communication apparatus 100 on the transmitting side transmits five sub-packets in the order of sub-packets #3 to #7. Like in the initial transmission shown in FIG. 4 (during transmission of sub-packets #1 to #5), setting section 101 sets transmission power of sub-packets #3 to #7 so that a sub-packet transmitted at an earlier time (here, a sub-packet with a lower sub-packet number) has higher transmission power.

As described above, when sub-packets #1 to #5 are initially transmitted (left side in FIG. 5), radio communication apparatus 200 on the receiving side receives sub-packets in descending order of transmission power (that is, receives sub-packets from the least error-prone sub-packet) and performs sub-packet processing (demodulation processing, decoding processing and the like) thereon. Thus, sub-packets (sub-packets #4, #5 shown in FIG. 5) received after the sub-packet in which an error is detected first have less set transmission power (higher error rate) than the sub-packet #3 (sub-packet having an error) and so are very likely to be in error. Thus, radio communication apparatus 200 on the receiving side can determine that subsequent sub-packets including the sub-packet in which an error was first detected are in error by detecting an error in the order in which a plurality of sub-packets in a transmission packet is received. Similarly, radio communication apparatus 100 on the transmitting side can determine that subsequent sub-packets including the sub-packet of the sub-packet number given as feedback are in error (that is, sub-packets that need to be retransmitted) only if feedback of the sub-packet number of the sub-packet in which an error was first detected in radio communication apparatus 200 on the receiving side is given. Thus, radio communication apparatus 200 on the receiving side stops sub-packet processing when an error is detected and gives feedback of only the sub-packet number of the sub-packet in which an error was detected. Accordingly, the amount of signaling necessary for feedback of a control signal can be reduced to a minimum and further, sub-packet processing of a sub-packet in which an error is reliably present is not performed, which eliminates waste of processing.

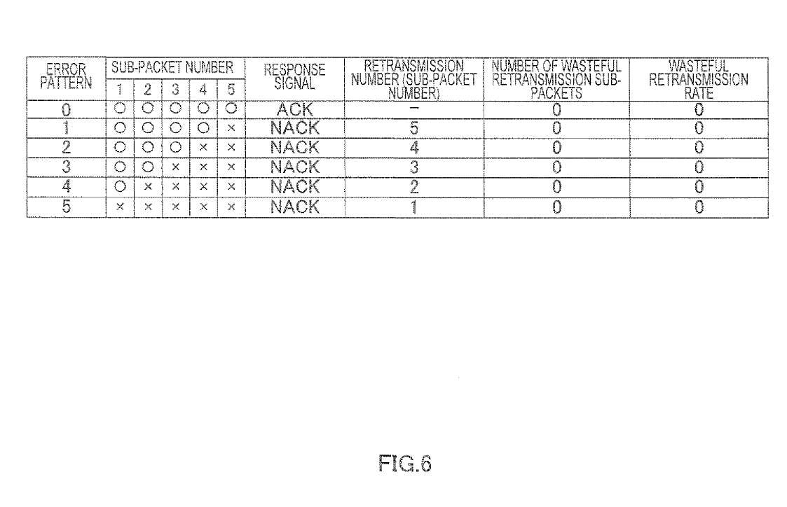

Error patterns of sub-packets #1 to #5 in the present embodiment have, as shown in FIG. 6, a total of six patterns including one pattern (error pattern 0) when there is no error and five patterns (error patterns 1 to 5) when an error is present. Specifically, as shown in FIG. 6, error patterns of sub-packets #1 to #5 include a case where there is no error in all of sub-packets #1 to #5 (error pattern 0), a case where there is an error in sub-packet #5 (error pattern 1), a case where there are errors in sub-packet #4 and thereafter (error pattern 2), a case where there are errors in sub-packet #3 and thereafter (error pattern 3), a case where there are errors in sub-packet #2 and thereafter (error pattern 4), and a case where there are errors in all of sub-packets #1 to #5 (error pattern 5). Thus, the amount of signaling for feedback of a control signal has three bits, the control signal can be represented.

In all error patterns, as shown in FIG. 6, the probability that subsequent sub-packets including the sub-packet of the retransmission number (the sub-packet number of the sub-packet in which an error was detected) are in error is very high. Thus, even when radio communication apparatus 100 on the transmitting side transmits the sub-packet of the retransmission number and all subsequent sub-packets, the number of sub-packets that are wastefully transmitted is 0 (that is, the wasteful retransmission rate is 0).

Thus, according to the present embodiment, a radio communication apparatus on the transmitting side sets mutually different transmission power to each of a plurality of sub-packets and transmits the plurality of sub-packets in descending order of transmission power, that is, in ascending order of error rate (that is, in descending order from the least error-prone sub-packet). A radio communication apparatus on the receiving side preferentially checks a sub-packet in which an error is less likely to occur to detect an error. Accordingly, with feedback of only the sub-packet in which an error is first detected being given to the radio communication apparatus on the transmitting side by the radio communication apparatus on the receiving side, the radio communication apparatus on the transmitting side can determine all sub-packets having an error and retransmit only sub-packets having an error. That is, according to the present embodiment, the amount of signaling can be suppressed like the GBN method when feedback of a control signal is given and high system throughput can be obtained like the SR method when sub-packets are retransmitted. Therefore, according to the present embodiment, system throughput can be improved while the amount of signaling of feedback is suppressed.

Also, according to the present embodiment, the error rate of sub-packets is controlled by setting transmission power to each of a plurality of sub-packets and thus, there is no need to change the transmission frame format.

Also, according to the present embodiment, a radio communication apparatus on the receiving side stops demodulation processing and decoding processing and thus, power consumption for the demodulation processing and decoding processing can be reduced. Further, by stopping the demodulation processing and decoding processing when an error is detected, the time necessary to give feedback of a response signal (NACK signal) to the radio communication apparatus on the transmitting side can be reduced so that a retransmission delay can be reduced.

### Embodiment 2

In the present embodiment, the radio communication apparatus on the transmitting side sets a mutually different error correction capability (Specifically, the error correction coding rate) to each of a plurality of sub-packets obtained by dividing a transmission packet.

Sub-packets having mutually different coding rates have different configuration ratios between the number of information bits (the number of systematic bits) and the number of redundant bits (the number of redundancy bits or parity bits) after coding. Specifically, a sub-packet in descending order of coding rate has a smaller number of information bits and a greater number of redundant bits. Thus, the radio communication apparatus on the receiving side can perform decoding processing by using more redundant bits on a sub-packet having a lower coding rate. That is, a sub-packet with a lower coding rate has more improved error rate characteristics (or decoding performance). In other words, a sub-packet with a lower coding rate has a lower error rate (for example, BLER).

Thus, a difference in error rate characteristics (decoding performance) between sub-packets arises resulting from the coding rate in a plurality of sub-packets having different coding rates.

Thus, in the present embodiment, the radio communication apparatus on the transmitting side sets mutually different coding rates to each of the plurality of sub-packets. The radio communication apparatus on the transmitting side also transmits, among the plurality of sub-packets, a sub-packet having a lower coding rate, that is, a sub-packet having a lower error rate at an earlier time.

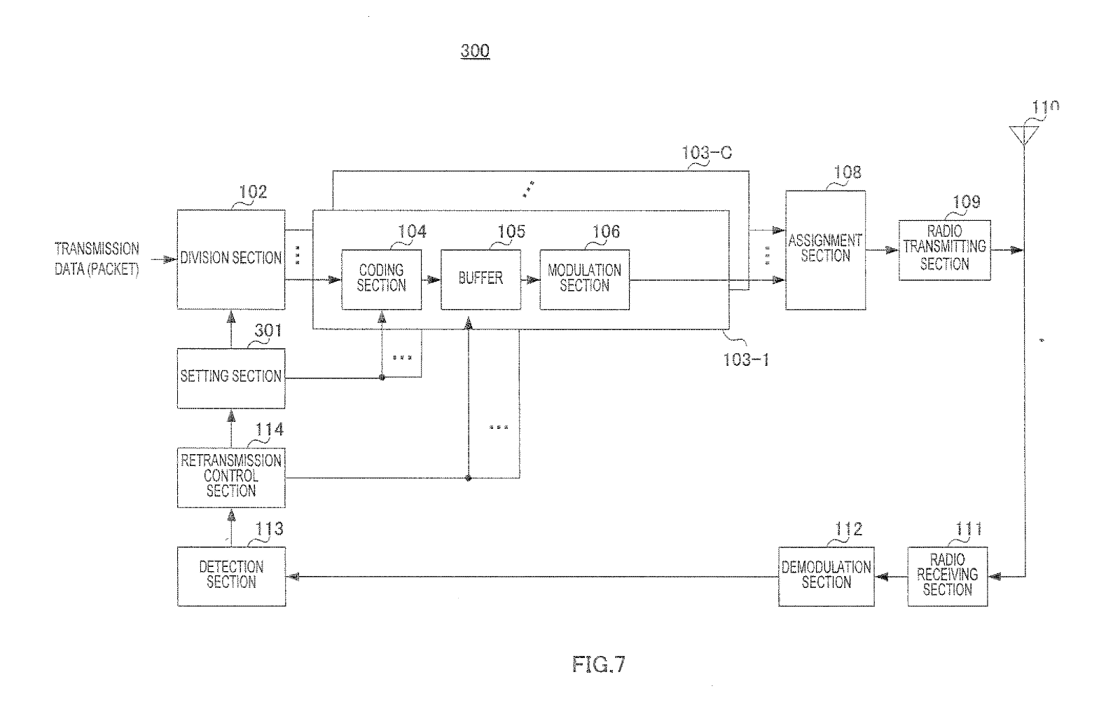

The configuration of radio communication apparatus 300 on the transmitting side according to the present embodiment is shown in FIG. 7. In FIG. 7, the same reference numerals are attached to the same structural elements as those in FIG. 2 (Embodiment 1) and a description thereof is omitted. In the present embodiment, no transmission power control is exercised and thus, power control section 107 shown in FIG. 2 is not needed for radio communication apparatus 300 on the transmitting side shown in FIG. 7.

Setting section 301 of radio communication apparatus 300 on the transmitting side shown in FIG. 7 sets mutually different coding rates to each of a plurality of sub-packets obtained by dividing transmission data (transmission packet). Setting section 301 sets mutually different coding rates to each of the plurality of sub-packets in such a way that the average coding rate of the plurality of sub-packets becomes equal to the coding rate assigned the transmission packet constituting the. plurality of sub-packets in advance. Further, setting section 301 sets mutually different coding rates to each of the plurality of sub-packets based on the coding rate set to each sub-packet so that the size of sub-packets after being coded becomes constant. That is, setting section 301 sets the coding rate to each of the plurality of sub-packets and also sets the size of each of the plurality of sub-packets obtained by dividing transmission data (transmission packet). Then, setting section 301 outputs sub-packet information indicating the set size of the sub-packet to division section 102 and also outputs coding rate information indicating the set coding rate to each coding section 104 of sub-packet processing sections 103-1 to 103-C.

Division section 102 divides transmission data (transmission packet) into a plurality of sub-packets according to sub-packet information input from setting section 301.

Each coding section 104 of sub-packet processing sections 103-1 to 103-C performs coding processing on sub-packets input from division section 102 by using the coding rate indicated by coding information input from setting section 301.

Next, details of retransmission processing by radio communication apparatus 300 on the transmitting side (FIG. 7) and radio communication apparatus 200 (FIG. 3) on the receiving side will be described.

In the description that follows, like in Embodiment 1, division section 102 of radio communication apparatus 300 on the transmitting side divides one transmission packet into five sub-packets (sub-packets #1 to #5). Radio communication apparatus 300 on the transmitting side transmits in the order of sub-packets #1 to #5. Coding rate R=1/2 is assigned to the transmission packet constituting sub-packets #1 to #5 in advance. Radio communication apparatus 200 on the receiving side is notified of the coding rate of each sub-packet set by setting section 301 of radio communication apparatus 300 on the transmitting side.

First, setting section 301 sets mutually different coding rates to sub-packets #1 to #5. Specifically, setting section 301 lowers the coding rate to make the error rate lower (less error-prone) of a sub-packet transmitted earlier. Here, setting section 301 sets mutually different coding rates to each of the plurality of sub-packets in such a way that the average coding rate of sub-packets #1 to #5 becomes equal to the coding rate (R=1/2) assigned to the transmission packet, constituting sub-packets #1 to #5 in advance.

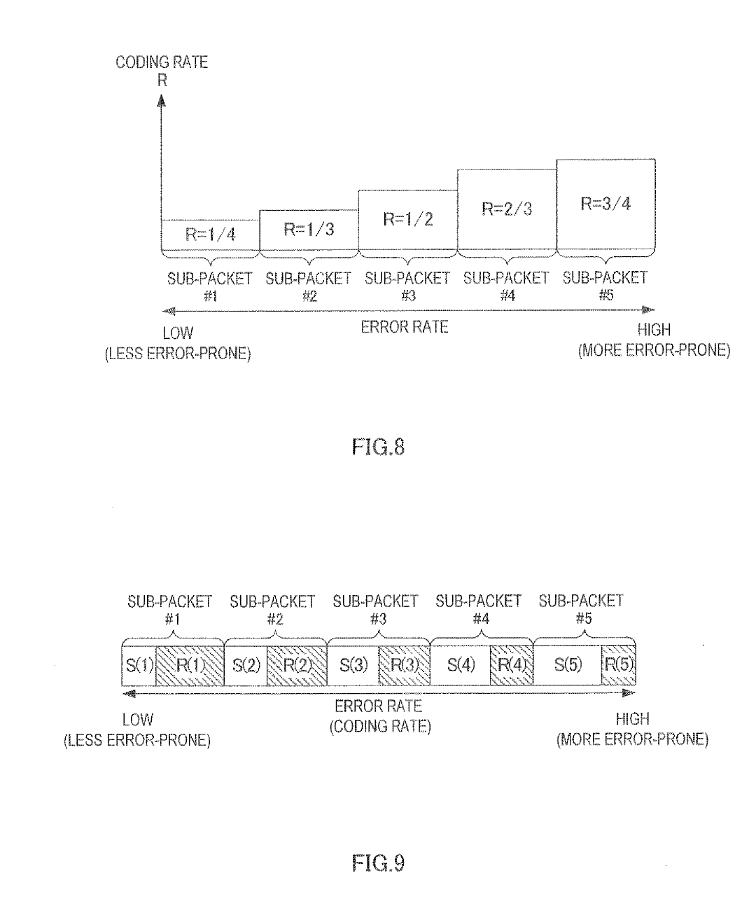

For example, as shown in FIG. 8, setting section 301 sets coding rate R. of sub-packet #1 to 1/4, coding rate R of sub-packet #2 to 1/3, coding rate R of sub-packet #3 to 1/2, coding rate R of sub-packet #4 to 2/3, and coding rate R of sub-packet #5 to 3/4. The average coding rate of sub-packets #1 to #5 becomes 1/2(=(1/4+1/3+1/2+2/3+3/4)/5).

Thus, in sub-packets #1 to #5 shown in FIG. 8, a difference in magnitude of the coding rate, that is, the error rate and a sub-packet with a lower sub-packet number (a sub-packet transmitted at an earlier time) has a lower coding rate. In other words, in sub-packets #1 to #5 shown in FIG. 8, a sub-packet with a lower sub-packet number has a lower error rate. By setting the coding rate of each sub-packet in this manner, like in Embodiment 1, setting section 301 adjusts the error rate (for example, BLER) of each sub-packet.

Setting section 301 also sets the sizes of sub-packets #1 to #5 when division section 102 divides transmission data (transmission packet) so that packet sizes of sub-packets #1 to #5 after being coded become equal. If the systematic code is used, as shown in FIG. 9, the ratio of redundant bits (R) to information bits (S) increases with a lower coding rate. Thus, to make the size (information bits (S)+redundant bits (R)) of sub-packets after being coded constant, setting section 301 decreases the size of a sub-packet (information bits (S)) with a lower set coding rate still more. Among sub-packets #1 to #5, for example, setting section 301 sets the size of sub-packet #1 (S(1) shown in FIG. 9) to which the lowest coding rate (R=1/4 shown in FIG. 8) is set smallest and the size of sub-packet #5 (S(5) shown in FIG. 9) to which the highest coding rate (R=3/4 shown in FIG. 8) is set largest.

Division section 102 divides transmission data (transmission packet) into a plurality of sub-packets #1 to #5 (S(1) to S(5) shown in FIG. 9) according to sub-packet information input from setting section 301.

Then, each coding section 104 of sub-packet processing sections (for example, sub-packet processing sections 103-1 to 103-5) corresponding to sub-packets #1 to #5 respectively codes sub-packets #1 to #5 (S(1) to S(5) shown in FIG. 9) input from division section 102 using coding information (FIGS) input from setting section 301. Accordingly, as shown in FIG. 9, the size (information bits (S)+redundant bits (R)) of sub-packets #1 to #5 after being coded will be constant.

Then, radio communication apparatus 300 on the transmitting side transmits the plurality of sub-packets in ascending order of coding rate, that is, in the order of sub-packets #1, #2, #3, #4, and #5. Accordingly, when sub-packets #1 to 45 are initially transmitted, like in Embodiment 1, the radio communication apparatus on the receiving side receives sub-packets in ascending order of coding rate, that is, sub-packets in descending order from the least error-prone sub-packet, and performs sub-packet processing (demodulation processing, decoding processing and the like). Then, the radio communication apparatus on the receiving side gives feedback of only the sub-packet number of the sub-packet in which an error was first detected. Then, radio communication apparatus 300 on the transmitting side retransmits only subsequent sub-packets including the sub-packet in which an error was first detected (that is, sub-packets having an error) in the radio communication apparatus on the receiving side.

Thus, according to the present embodiment, like in Embodiment 1, with mutually different coding rates being set to each of a plurality of sub-packets by the radio communication apparatus on the transmitting side, system throughput can be improved while the amount of signaling of feedback being suppressed.

Further, according to the present embodiment, the size of sub-packets after being coded is constant between a plurality of sub-packets in a transmission packet and thus, the number of data symbols before demodulation or the number of pieces of reliability information (for example, the likelihood ratio of number to reception or reception likelihood) before demodulation is constant between the plurality of sub-packets. Thus, in the radio communication apparatus on the receiving side, HARQ processing in units of sub-packets can be performed without consideration of the size between a plurality of sub-packets in processing prior to demodulation processing and so the circuit configuration for the processing prior to the demodulation processing becomes simpler. Moreover, the unit of radio resources in a radio transmission period can be unified by making the size of sub-packets after being coded constant between the plurality of sub-packets in a transmission packet and so management of radio resources becomes easier.

Further, according to the present embodiment, the average coding rate of sub-packets in a transmission packet and the coding rate assigned to the transmission packet in advance are equal and so there is no need to change the correspondence between a target error rate in units of transmission packets and an MCS (Modulation and Coding Scheme) table. That is, there is an advantage that an MCS system is less affected even when mutually different coding rates are set to the plurality of sub-packets.

In the present embodiment, a ease where the coding rate of systematic code is set has been described. However, the error correction code applied to the present embodiment is not limited to the systematic code and any error correction code in which a difference in error rate arises depending on the coding rate such as the convolutional code and Reed-Solomon code is applicable.

### Embodiment 3

In Embodiment 1 and Embodiment 2, when one transmission packet is divided into a plurality of sub-packets, the radio communication apparatus on the receiving side can detect an error in units of finer sub-packets with a greater number of divisions (with a greater number of sub-packets). Thus, sub-packets requested to retransmit can be reduced to a minimum, further improving system throughput.

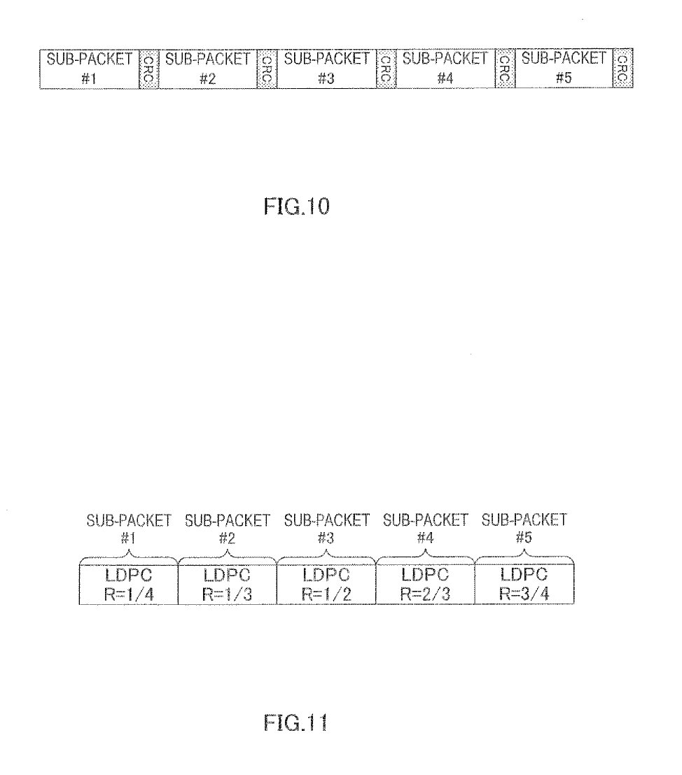

However, it is necessary for the radio communication apparatus on the receiving side to use the error detection code such as the CRC code for each sub-packet to detect an error from each sub-packet. For example, when one transmission packet is divided into five sub-packets 41 to #5, as shown in FIG. 10, it is necessary for the radio communication apparatus on the transmitting side to add the CRC code to each of sub-packets #1 to #5. Thus, the CRC code to be added increases with a greater number of divisions of a transmission packet. That is, if the number of divisions of a transmission packet is large, an influence of overheads of the error detection code such as the CRC code on system throughput may be too large to be ignored.

Thus, in the present embodiment, the radio communication apparatus on the transmitting side codes a plurality of sub-packets by using error correction code capable of also detecting an error in error correction decoding. The error correction code capable of also detecting an error in error correction decoding includes, for example, the LDPC (Low-Density Parity-Check) code and BCH code, but the error correction code is not limited to these codes.

For example, a case where, like in Embodiment 2, mutually different coding rates (for example, coding rates shown in FIG. 8) are set to sub-packets #1 to #5 obtained by dividing one transmission packet will be described. Radio communication apparatus 300 (FIG. 7) on the transmitting side according to the present embodiment codes sub-packets #1 to #5 by using the LDPC code.

That is, in radio communication apparatus 300 (FIG. 7) on the transmitting side, as shown in FIG. 11, each coding section 104 of sub-packet processing sections (for example, sub-packet processing sections 103-1 to 103-5) corresponding to sub-packets #1 to #5 respectively LDPC-codes sub-packets #1 to #5 respectively. Since the LDPC code can also detect an error and thus, as shown in FIG. 11, no error detection code is added to sub-packets #1 to #5. Thus, even if the number of divisions of a transmission packet is large, overheads due to the error detection code do not arise so that degradation in system throughput is not caused.

Thus, according to the present embodiment, the radio communication apparatus on the transmitting side codes a plurality of sub-packets obtained by dividing a transmission packet by using error correction code capable of also detecting an error as the error correction code. Accordingly, overheads due to the error detection code do not arise and even if the number of divisions of a transmission packet is large, effects like those of Embodiment 1 and Embodiment 2 can be gained without causing degradation in system throughput.

### Embodiment 4

In the present embodiment, when a sub-packet in which an error was detected is retransmitted, the radio communication apparatus on the transmitting side sets the error rate for retransmission of a sub-packet lower with a higher error rate for initial transmission (last transmission).

Details of retransmission processing by radio communication apparatus 300 (FIG. 7) on the transmitting side according to the present embodiment and radio communication apparatus 200 (FIG. 3) on the receiving side according to the present embodiment will be described below.

In the description that follows, like in Embodiment 2, division section 102 of radio communication apparatus 300 on the transmitting side divides one transmission packet into five sub-packets (sub-packets #1 to #5). In the initial transmission, radio communication apparatus 300 on the transmitting side transmits a plurality of sub-packets in the order of sub-packets #1 to #5 Coding rate R=1/2is assigned to the transmission packet constituting sub-packets #1 to #5 in advance. Radio communication apparatus 200 on the receiving side is notified of the coding rate of each sub-packet set by setting section 301 of radio communication apparatus 300 on the transmitting side.

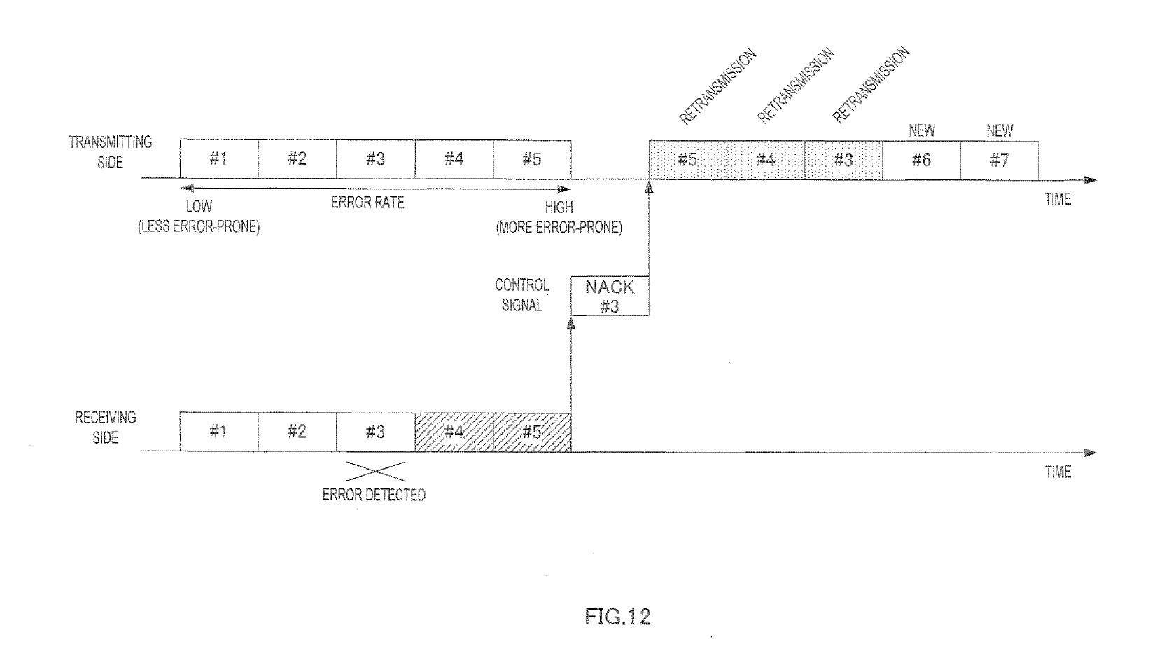

Here, as shown in FIG. 12, a case where radio communication apparatus 200 on the receiving side detects an error in sub-packet #3 will be described. That is, radio communication apparatus 300 on the transmitting side retransmits subsequent sub-packets #3 to #5 including sub-packet #3.

Specifically, since the sub-packet number indicated in the control signal is ‘#3’, retransmission control section 114 of radio communication apparatus 300 on the transmitting side instructs each buffer 105 of sub-packet processing sections corresponding to sub-packets #3 to #5 of sub-packet processing sections 103-1 to 103-5 to retransmit. Here, retransmission control section 114 instructs each buffer 105 to retransmit so that sub-packets #3 to #5 are transmitted in the order opposite to the transmission order for initial transmission (that is, in the order of sub-packets #5 to #3). Then, for example, each buffer 105 outputs saved sub-packets #5 to #3 to assignment section 108 and assignment section 108 assigns sub-packets #5 to #3 in this order starting with the head of physical channel resources starting one by one.

Like in Embodiment 2, setting section 301 lowers the coding rate of a sub-packet transmitted at an earlier time to lower the error rate (to make the sub-packet less error-prone). Here, setting section 301 sets the coding rate for retransmission lower (the error rate lower) of a sub-packet with a higher coding rate for initial transmission (that is, a sub-packet with a higher error rate). Specifically, setting section 301 sets the coding rate for retransmission lower for sub-packet #5 with a higher coding rate for initial transmission of sub-packets #3 to #5. However, like Embodiment 2, setting section 301 sets mutually different coding rates to each of a plurality of sub-packets in such a way that the average coding rate of the plurality of sub-packets becomes equal to the coding rate assigned to the transmission packet constituting the plurality of sub-packets in advance.

Accordingly, in sub-packets #5 to #3 shown in FIG. 12, a difference in magnitude of the coding rate, that is, the error rate arises and, among sub-packets to be retransmitted, a sub-packet with a greater sub-packet number (a sub-packet transmitted at an earlier time) has a lower coding rate. In other words, in sub-packets #5 to #3 for retransmission shown in FIG. 12, the error rate decreases with a greater sub-packet number. By setting the coding rate of each sub-packet in this manner, like in Embodiment 2, setting section 301 adjusts the error rate (for example, BLER) of each sub-packet.

Then, radio communication apparatus 300 on the transmitting side transmits, as shown in FIG. 12, the plurality of sub-packets in ascending order of coding rate, that is, in the order of sub-packets #5, #4, #3, #6, and #7. That is, radio communication apparatus 300 on the transmitting side transmits, as shown in FIG. 12, among sub-packets #3 to #5 to be retransmitted, a sub-packet for which an error is more likely to occur during initial transmission at an earlier time. Namely, radio communication apparatus 300 on the transmitting side transmits the plurality of sub-packets during retransmission (right side in FIG. 12) in descending order of coding rate during initial transmission (left side in FIG. 12), that is, in descending order of likelihood of an error occurrence during initial transmission.

Also during retransmission of sub-packets, radio communication apparatus 200 on the receiving side receives, like during initial transmission, sub-packets in ascending order of coding rate, that is, in descending order from the least error-prone sub-packet, and performs sub-packet processing (demodulation processing, decoding processing and the like) thereon. That is, in radio communication apparatus 200 on the receiving side, sub-packet processing is performed in the order of sub-packets #5, #4, and #3.

Thus, according to the present embodiment, like in Embodiment 2, with mutually different coding rates being set to each of a plurality of sub-packets by a radio communication apparatus on the transmitting side for initial transmission and retransmission, system throughput can be improved while the amount of signaling of feedback being suppressed.

Further, according to the present embodiment, the radio communication apparatus on the transmitting side sets the coding rate (error rate) for retransmission lower for a sub-packet with a higher coding rate (error rate) for initial transmission. Accordingly, a radio communication apparatus on the receiving side can improve reception quality of retransmitted sub-packets on average and so can lower the error rate of all sub-packets (that is, make sub-packet less error-prone) by retransmission of sub-packets.

In the present embodiment, a case where the coding rate of systematic code is set has been described. However, the error correction code applied to the present invention is not limited to the systematic code and any error correction code in which a difference in error rate arises depending on the coding rate such as the convolutional code and Reed-Solomon code is applicable.

### Embodiment 5

In the present embodiment, when a sub-packet in which an error was detected is retransmitted, the radio communication apparatus on the transmitting side sets an error rate lower than the error rate set for the last transmission to sub-packets to be retransmitted of a plurality of sub-packets transmitted last time.

Details of retransmission processing by radio communication apparatus 300 (FIG. 7) on the transmitting side according to the present embodiment and radio communication apparatus 200 (FIG. 3) on the receiving side according to the present embodiment will be described below.

In the description that follows, like in Embodiment 2, division section 102 of radio communication apparatus 300 on the transmitting side divides one transmission packet into five sub-packets (sub-packets #1 to #5). Radio communication apparatus 300 on the transmitting side transmits in the order of sub-packets #1 to #5. Coding rate R=1/2is assigned to the transmission packet constituting sub-packets #1 to #5 in advance. Setting section 301 of radio communication apparatus 300 on the transmitting side sets, like in Embodiment 2, as shown in FIG. 8, mutually different error rates to each of a plurality of sub-packets by setting 1/4, 1/3, 1/2, 2/3, and 3/4 as coding rate R of sub-packets #1 to #5 respectively for initial transmission. Radio communication apparatus 200 on the receiving side is notified of the coding rate of each sub-packet set by setting section 301 of radio communication apparatus 300 on the transmitting side.

Here, a case where radio communication apparatus 200 on the receiving side detects an error in sub-packet #3 will be described. That is, radio communication apparatus 300 on the transmitting side retransmits subsequent sub-packets #3 to #5 including sub-packet 43.

Setting section 301 of radio communication apparatus 300 on the transmitting side sets an error rate lower than the error rate set for initial transmission, that is, a coding rate lower than the coding rate set for initial transmission to each of sub-packets to be transmitted (here, sub-packets #3 to #5) for retransmission. For example, as shown in FIG. 13, setting section 301 sets coding rate R=1/5 lower than coding rate R=1/2 set for initial transmission to sub-packet 3. Similarly, setting section 301 sets, as shown in FIG. 13, coding rate R=1/4 lower than coding rate R=2/3 set for initial transmission to sub-packet 4. Similarly, setting section 301 sets, as shown in FIG. 13, coding rate R=1/3 lower than coding rate R=3/4 set for initial transmission to sub-packet 5.

In sub-packets #3 to #5 for retransmission shown in FIG. 13, a sub-packet of sub-packets to be retransmitted has a larger degree of reducing the coding rate for retransmission with a greater sub-packet number (a sub-packet with a higher coding rate for initial transmission). In other words, in sub-packets #3 to #5 for retransmission shown in FIG. 13, a sub-packet with a greater sub-packet number has a larger degree of reducing the error rate compared with the time of initial transmission. By setting the coding rate of each sub-packet in this manner, like in Embodiment 4, setting section 301 adjusts the error rate (for example, BLER) of each sub-packet.

Thus, according to the present embodiment, like in Embodiment 4, with mutually different coding rates being set to each of a plurality of sub-packets for retransmission by a radio communication apparatus on the transmitting side, system throughput can be improved while the amount of signaling of feedback being suppressed.

Further, according to the present embodiment, the radio communication apparatus on the transmitting side sets the coding rate (error rate) for retransmission lower than the coding rate (error rate) for initial transmission to a sub-packet in which an error was detected during initial transmission. That is, a sub-packet in which an error was detected during initial transmission becomes less error-prone during retransmission. Accordingly, the radio communication apparatus on the receiving side can reliably improve reception quality of retransmitted sub-packets so that the possibility of an occurrence of error during retransmission can be reduced. Also, according to the present embodiment, the radio communication apparatus on the transmitting side increases the degree of reducing the error rate (coding rate) for retransmission for a sub-packet with a higher error rate (coding rate) for initial transmission. Accordingly, a sub-packet with a higher error rate (that is, a more error-prone sub-packet) for initial transmission can be made less error-prone for retransmission.

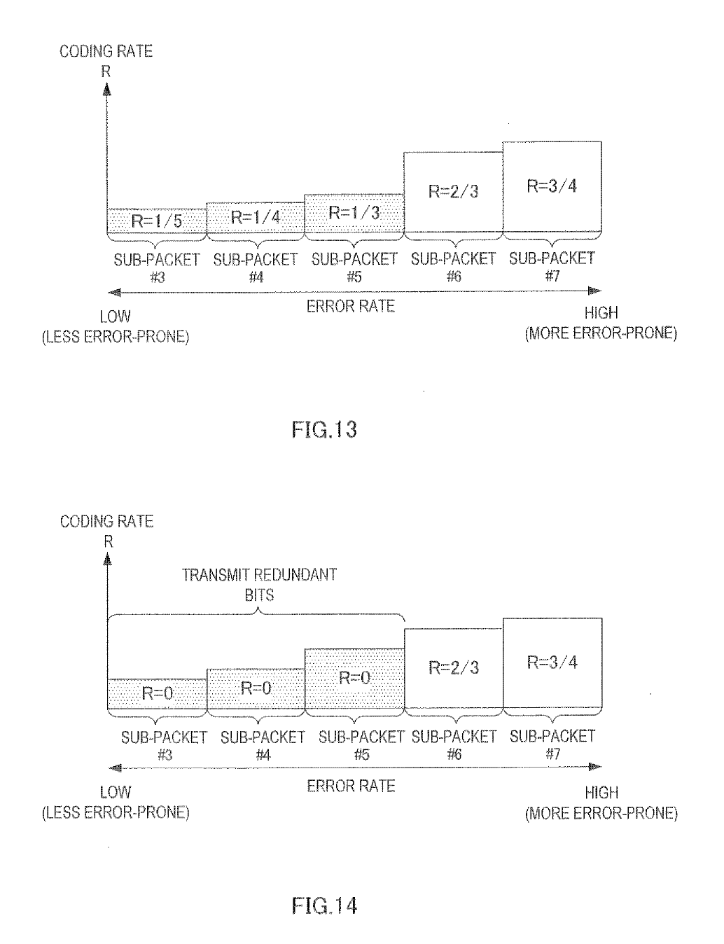

In the present embodiment, as shown in FIG. 14, the radio communication apparatus on the transmitting side may set only redundant bits (parity bits) as a signal to be transmitted for sub-packets #3 to #5 for retransmission. Accordingly, the radio communication apparatus on the receiving side can further lower coding rate R (R=0) of sub-packets for retransmission by performing IR (Incremental Redundancy) processing in HARQ. In sub-packets #3 to #5 shown in FIG. 14, a sub-packet with a greater sub-packet number has a larger degree of reducing the error rate (coding rate) for retransmission with respect to the error rate (coding rate) for initial transmission. By setting the coding rate of each sub-packet in this manner, like in the present embodiment, the radio communication apparatus (setting section 301) on the receiving side may adjust the error rate (for example, BLER) of each sub-packet.

### Embodiment 6

In the present embodiment, when a sub-packet in which an error was detected is retransmitted, the radio communication apparatus on the transmitting side sets the highest coding rate of coding rates set to sub-packets without error in the last transmission as the lowest coding rate for retransmission and the coding rate set to the sub-packet in which an error was detected in the last transmission as the highest coding rate for retransmission.

Details of retransmission processing by radio communication apparatus 300 (FIG. 7) on the transmitting side according to the present embodiment and radio communication apparatus 200 (FIG. 3) on the receiving side according to the present embodiment will be described below.

In the description that follows, like in Embodiment 1, division section 102 of radio communication apparatus 300 on the transmitting side divides one transmission packet into five sub-packets (sub-packets #1 to #5). Radio communication apparatus 300 on the transmitting side transmits in the order of sub-packets #1 to #5. Radio communication apparatus 200 on the receiving side is notified of the coding rate of each sub-packet set by setting section 301 of radio communication apparatus 300 on the transmitting side.

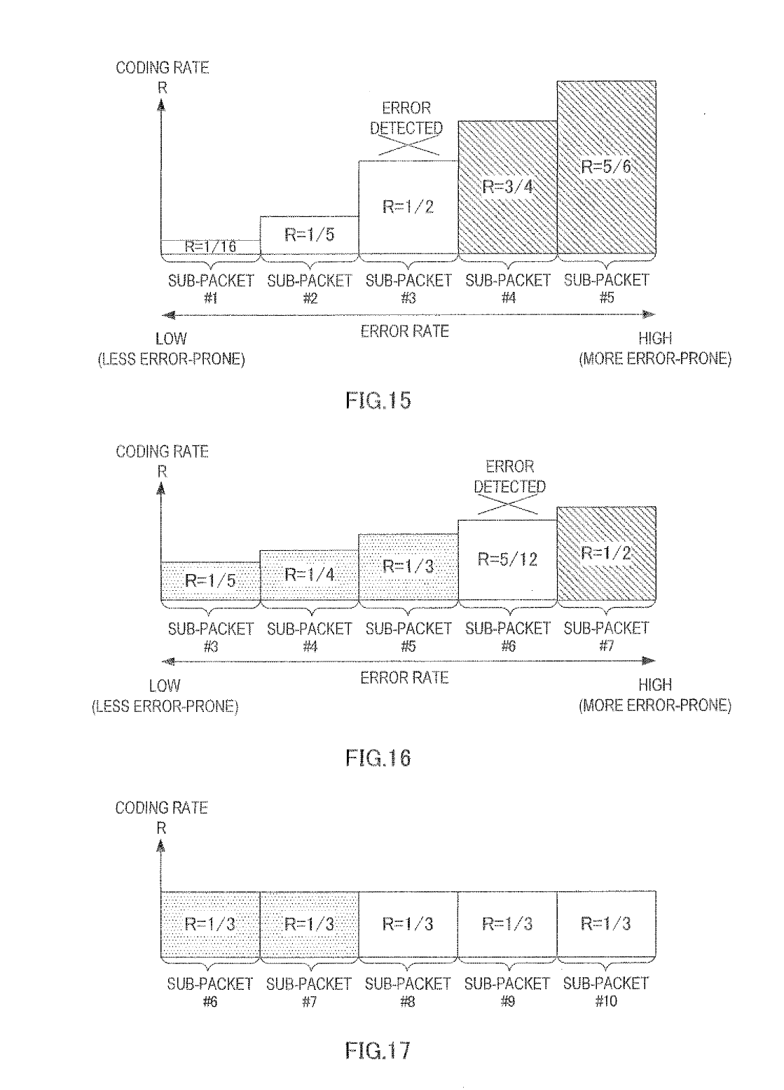

First, as shown in FIG. 15, setting section 301 of radio communication apparatus 300 on the transmitting side sets coding rates R=1/16, 1/5, 1/2, 3/4, and 5/6 to sub-packets #1 to #5 for initial transmission respectively.

Here, as shown in FIG. 15, a case where radio communication apparatus 200 on the receiving side detects an error in sub-packet #3 will be described. That is, radio communication apparatus 300 on the transmitting side retransmits subsequent sub-packets #3 to #5 including sub-packet #3.

At this point, setting section 301 of radio communication apparatus 300 on the transmitting side sets mutually different coding rates to each of sub-packets to be retransmitted between the maximum value of the coding rates of sub-packets received normally (sub-packets without error) during initial transmission (last transmission) and the coding rate of the sub-packet in which an error was detected.

Specifically, when a plurality of sub-packets is retransmitted, setting section 301 sets, as shown in FIG. 15, the highest coding rate R=1/5 of the coding rates set to sub-packets without error (sub-packets #1 and #2) during initial transmission as the lowest coding rate for retransmission. Setting section 301 also sets, as shown in FIG. 15, coding rate R=1/2 set to the sub-packet (sub-packet #3) in which an error was detected during initial transmission as the highest coding rate for retransmission. That is, setting section 301 sets coding rates between the coding rates R =1/5 and 1/2 to sub-packets #3 to #5 and new sub-packets #6 and #7 transmitted during retransmission of sub-packets #3 to #5.

For example, as shown in FIG. 16, setting section 301 sets coding rate R of sub-packet #3 to be retransmitted to 1/5 (that is, the maximum value of the coding rates of sub-packets normally received during initial transmission), coding rate R of sub-packet #4 to 1/4, and coding rate R of sub-packet #5 to 1/3. Setting section 301 also sets coding rate R of new sub-packet #6 to 5/12 and coding rate R of sub-packet #7 to 1/2 (coding rate of the sub-packet in which an error was detected during initial transmission).

Further, as shown in FIG. 16, a case where radio communication apparatus 200 on the receiving side detects an error in sub-packet #6 will be described. That is, radio communication apparatus 300 on the transmitting side retransmits subsequent sub-packets #6 and #7 including sub-packet #6.

In this case, radio communication apparatus 200 on the receiving side has received all retransmitted sub-packets #3 to shown in FIG. 16 normally. Accordingly, radio communication apparatus 300 on the transmitting side and radio communication apparatus 200 on the receiving side determines that no error will occur if each sub-packet is transmitted with the highest coding rate R=1/3 of the coding rates set to sub-packets #3 to #5 for retransmission. Thus, radio communication apparatus 300 on the transmitting side transmits all sub-packets in the next and subsequent transmission by setting coding rate R to 1/3. That is, as shown in FIG. 17, setting section 301 of radio communication apparatus 300 on the transmitting side sets coding rate R of 1/3 to all of sub-packets #6 and #7 to be retransmitted and new sub-packets #8 to #10. Accordingly, radio communication apparatus 200 on the receiving side is more likely to receive all sub-packets normally so that the number of times of retransmission can be reduced.

Thus, according to the present embodiment, like in Embodiment 4, with mutually different coding rates being set to each of a plurality of sub-packets by a radio communication apparatus on the transmitting side, system throughput can be improved while the amount of signaling of feedback being suppressed.

Further, according to the present embodiment, the radio communication apparatus on the transmitting side finely adjusts the coding rate of each sub-packet in a narrower range (for example, R=1/5 to 1/2 shown in FIG. 16) than that of the coding rates set for the last transmission (for example, R=1/16 to 5/6 shown in FIG. 15). Accordingly, the radio communication apparatus on the transmitting side can reliably adjust the error rate (for example, BLER) of each sub-packet so that wasteful retransmission will not arise.

Further, according to the present embodiment, if no error occurs in any of all retransmitted sub-packets as a result of repeated retransmission, the radio communication apparatus on the transmitting side sets the highest coding rate of the coding rates set to retransmitted sub-packets as the coding rate of all sub-packets in the next and subsequent transmission. Accordingly, the radio communication apparatus on the receiving side is more likely to receive all sub-packets normally in the next and subsequent transmission so that the number of times of retransmission can be reduced.

In the present embodiment, a case where the coding rate . of systematic code is set has been described. However, the error correction code applied to the present embodiment is not limited to the systematic code and any error correction code in which a difference in error rate arises depending on the coding rate such as the convolutional code and Reed-Solomon code is applicable.

In the foregoing, each embodiment of the present invention has been described.

In the above embodiments, a case where, among a plurality of sub-packets in a transmission packet, a sub-packet with a lower error rate (that is, a sub-packet that is less error prone) is transmitted at an earlier time has been described. However, the present embodiment is not limited to a case where a sub-packet with a lower error rate is transmitted at an earlier time and it is only necessary that demodulation processing and decoding processing of sub-packets be performed by the radio communication apparatus on the receiving side in ascending order of error rate. For example, the radio communication apparatus on the transmitting side may interleave a plurality of sub-packets to which mutually different error rates are set in one transmission packet for transmission.

In a mobile communication system, radio communication apparatus 100 (FIG. 2), 300 (FIG. 7) on the transmitting side or radio communication apparatus 200 (FIG. 3) on the receiving side may be provided as a radio communication base station device. Also, radio communication apparatus 100 (FIG. 2), 300 (FIG. 7) on the transmitting side or radio communication apparatus 200 (FIG. 3) on the receiving side may be provided as a radio communication mobile station device. Accordingly, a radio communication base station device and radio communication mobile station device achieving an operation/effect as described above can be realized. Also, radio communication apparatus 100 (FIG. 2), 300 (FIG. 7) on the transmitting side or radio communication apparatus 200 (FIG. 3) on the receiving side may be provided as a radio communication relay station device that delays a signal of a radio communication apparatus.

The above embodiments have been described by applying the present invention to a radio communication apparatus, but may also be applied to another wire communication apparatus or optical communication apparatus capable of communicating by providing a difference of the error rate.

Also, although cases have been described with the above embodiment as examples where the present invention is configured by hardware, the present invention can also be realized by software.

Each function block employed in the description of each of the aforementioned embodiments may typically be implemented as an LSI constituted by an integrated circuit.

These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosures of Japanese Patent Application No. 2008-328286, filed on Dec. 24, 2008, and Japanese Patent Application No. 2009-079675, filed on Mar. 27, 2009, including the specifications, drawings and abstracts, are incorporated herein by their entirety.

### INDUSTRIAL APPLICABILITY

The present invention can be applied to a mobile communication system or the like.

1-13. (canceled)

14. A radio communication apparatus, comprising:
a division section that divides a transmission packet into a plurality of sub-packets;
a setting section that sets mutually different error rates to each of the plurality of sub-packets; and
a transmission section that transmits the plurality of sub-packets in ascending order of the error rate.

15. The radio communication apparatus according to claim 14, wherein the transmission section transmits, among the plurality of sub-packets, the sub-packet with a lower error rate at an earlier time.

16. The radio communication apparatus according to claim 14, wherein the setting section sets the mutually different error rates to each of the plurality of sub-packets by setting mutually different transmission power to each of the plurality of sub-packets.

17. The radio communication apparatus according to claim 16, wherein the setting section sets the mutually different transmission power to each of the plurality of sub-packets in such a way that a total of the transmission power for each of the plurality of sub-packets is equal to the transmission power assigned to the transmission packet in advance.

18. The radio communication apparatus according to claim 16, wherein the transmission section transmits the plurality of sub-packets in descending order of the transmission power.

19. The radio communication apparatus according to claim 14, wherein the setting section sets the mutually different error rates to each of the plurality of sub-packets by setting mutually different coding rates to each of the plurality of sub-packets.

20. The radio communication apparatus according to claim 19, wherein the setting section sets the mutually different coding rates to each of the plurality of sub-packets in such a way that an average of the coding rate of the plurality of sub-packets is equal to the coding rate assigned to the transmission packet in advance.

21. The radio communication apparatus according to claim 19, wherein the transmission section transmits the plurality of sub-packets in ascending order of the error rate.

22. The radio communication apparatus according to claim 14, wherein the setting section sets the error rate for retransmission lower for the sub-packet with a higher error rate for the previous transmission.

23. The radio communication apparatus according to claim 14, wherein the setting section sets the error rate lower than the error rate set for the previous transmission to the sub-packets to be retransmitted of the plurality of sub-packets in a previous transmission.

24. The radio communication apparatus according to claim 23, wherein the setting section increases a degree of reducing the error rate for retransmission lower for the sub-packet with a higher error rate for the previous transmission.

25. The radio communication apparatus according to claim 14, wherein, when the plurality of sub-packets is retransmitted, the setting section sets a highest coding rate of the coding rates set to the sub-packets without error during the previous transmission as the lowest coding rate for retransmission and the coding rate set to the sub-packet in which an error was detected during the previous transmission as the highest coding rate for retransmission.

26. A sub-packet transmission method, comprising the steps of:
setting mutually different error rates to each of a plurality of sub-packets obtained by dividing a transmission packet; and
transmitting the plurality of sub-packets in ascending order of the error rate.
